(19) United States
(12) Patent Application Publication
(10) Pub. No.: US 2023/0252714 A1
(43) Pub. Date: Aug. 10, 2023

(54) SHAPE AND APPEARANCE RECONSTRUCTION WITH DEEP GEOMETRIC REFINEMENT

(71) Applicants: DISNEY ENTERPRISES, INC., Burbank, CA (US); ETH Zürich (Eidgenössische Technische Hochschule Zürich), Zurich (CH)

(72) Inventors: Derek Edward BRADLEY, Zurich (CH); Prashanth CHANDRAN, Zurich (CH); Paulo Fabiano URNAU GOTARDO, Zurich (CH); Christopher Andreas OTTO, Zurich (CH); Agon SERIFI, Ostermundigen (CH); Gaspard ZOSS, Zurich (CH)

(21) Appl. No.: 17/669,053

(22) Filed: Feb. 10, 2022

(51) Int. Cl. G06T 15/04; G06T 15/20; G06T 7/00; G06V 40/16

(52) U.S. Cl. CPC G06T 15/04; G06T 7/97; G06T 15/205; G06V 40/169

(57) ABSTRACT

One embodiment of the present invention sets forth a technique for performing shape and appearance reconstruction. The technique includes generating a first set of renderings associated with an object based on a set of parameters that represent a reconstruction of the object in a first target image. The technique also includes producing, via a neural network, a first set of corrections associated with at least a portion of the set of parameters based on the first target image and the first set of renderings. The technique further includes generating an updated reconstruction of the object based on the first set of corrections.

### BACKGROUND

### Field of the Various Embodiments

Embodiments of the present disclosure relate generally to machine learning and computer vision, more specifically, to shape and appearance reconstruction with deep geometric refinement.

### Description of the Related Art

Realistic digital faces are required for various computer graphics and computer vision applications. For example, digital faces are oftentimes used in virtual scenes of film or television productions and in video games.

To capture photorealistic faces, a typical facial capture system employs a specialized light stage and hundreds of lights that are used to capture numerous images of an individual face under multiple illumination conditions. The facial capture system additionally employs multiple calibrated camera views, uniform or controlled patterned lighting, and a controlled setting. Further, a given face is typically scanned during a scheduled block of time, in which the corresponding individual can be guided into different expressions to capture images of individual faces. The resulting images can then be used to determine three-dimensional (3D) geometry and appearance maps that are needed to synthesize digital versions of the face.

Because existing facial capture systems require controlled settings and the physical presence of the corresponding individuals, these facial capture systems cannot be used to perform facial reconstruction under various uncontrolled “in the wild” conditions that include arbitrary human identity, facial expression, single point of view, and/or undetermined lighting environment. For example, film and television productions increasingly utilize 3D facial geometry for actors at a younger age, or actors who have passed away. The only imagery available for these types of facial geometry is “legacy” footage from old movies and internet photo collections. This “legacy” footage typically lacks multiple camera views, calibrated camera parameters, controlled lighting, desired expressions into which the actor can be guided, and/or other constraints that are required by a conventional facial capture technique to construct a 3D geometry. The conventional facial capture technique would similarly be unable to construct a realistic 3D avatar of a user, given images of the user captured by a mobile phone or camera under uncontrolled conditions.

As the foregoing illustrates, what is needed in the art are more effective techniques for generating digital faces outside of controlled settings for performing facial capture.

### SUMMARY

One embodiment of the present invention sets forth a technique for performing shape and appearance reconstruction. The technique includes generating a first set of renderings associated with an object based on a set of parameters that represent a reconstruction of the object in a first target image. The technique also includes producing, via a neural network, a first set of corrections associated with at least a portion of the set of parameters based on the first target image and the first set of renderings. The technique further includes generating an updated reconstruction of the object based on the first set of corrections.

One technical advantage of the disclosed techniques relative to the prior art is that faces and other types of objects can be reconstructed under uncontrolled “in the wild” conditions. Accordingly, the disclosed techniques can be used to perform shape and appearance reconstruction for objects that cannot be captured under controlled studio-like settings. Another technical advantage of the disclosed techniques is an improvement in reconstruction accuracy over conventional parametric models that are created from limited datasets of faces or other objects. For example, the disclosed techniques could be used to add granular details to a face after the reconstruction of the face is produced via a conventional parametric model. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a system configured to implement one or more aspects of various embodiments.

FIG. 2 illustrates the operation of the parameter estimation engine of FIG. 1, according to various embodiments.

FIG. 3 illustrates the operation of the refinement engine of FIG. 1, according to various embodiments.

FIG. 4 illustrates the preparation of training data for the machine learning model of FIG. 3, according to various embodiments.

FIG. 5 is a flow diagram of method steps for performing shape and appearance reconstruction, according to various embodiments.

### DETAILED DESCRIPTION

In the following description, numerous specific details are set forth to provide a more thorough understanding of the various embodiments. However, it will be apparent to one of skill in the art that the inventive concepts may be practiced without one or more of these specific details.

### System Overview

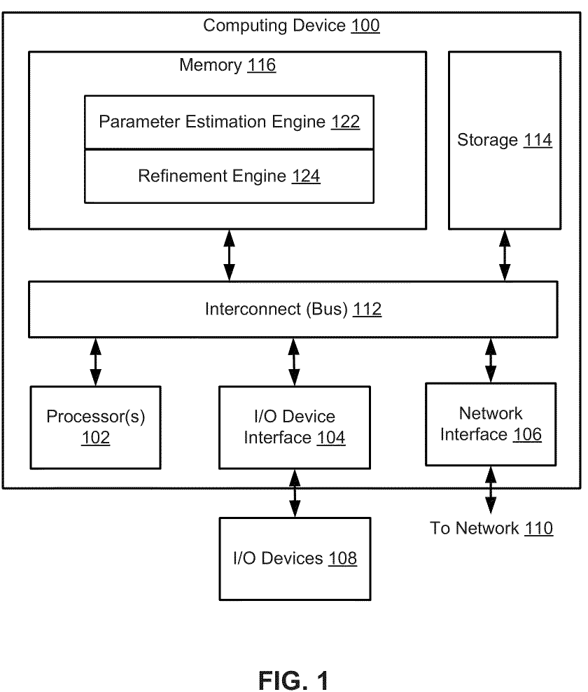

FIG. 1 illustrates a computing device 100 configured to implement one or more aspects of various embodiments. In one embodiment, computing device 100 may be a desktop computer, a laptop computer, a smart phone, a personal digital assistant (PDA), tablet computer, or any other type of computing device configured to receive input, process data, and optionally display images, and is suitable for practicing one or more embodiments. Computing device 100 is configured to run a parameter estimation engine 122 and a refinement engine 124 that reside in a memory 116.

It is noted that the computing device described herein is illustrative and that any other technically feasible configurations fall within the scope of the present disclosure. For example, multiple instances of parameter estimation engine 122 and refinement engine 124 could execute on a set of nodes in a distributed system to implement the functionality of computing device 100.

In one embodiment, computing device 100 includes, without limitation, an interconnect (bus) 112 that connects one or more processors 102, an input/output (I/O) device interface 104 coupled to one or more input/output (I/O) devices 108, memory 116, a storage 114, and a network interface 106. Processor(s) 102 may be any suitable processor implemented as a central processing unit (CPU), a graphics processing unit (GPU), an application-specific integrated circuit (ASIC), a field programmable gate array (FPGA), an artificial intelligence (Al) accelerator, any other type of processing unit, or a combination of different processing units, such as a CPU configured to operate in conjunction with a GPU. In general, processor(s) 102 may be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

I/O devices 108 include devices capable of providing input, such as a keyboard, a mouse, a touch-sensitive screen, and so forth, as well as devices capable of providing output, such as a display device. Additionally, I/O devices 108 may include devices capable of both receiving input and providing output, such as a touchscreen, a universal serial bus (USB) port, and so forth. 1/0 devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

Network 110 is any technically feasible type of communications network that allows data to be exchanged between computing device 100 and external entities or devices, such as a web server or another networked computing device. For example, network 110 may include a wide area network (WAN), a local area network (LAN), a wireless (WiFi) network, and/or the Internet, among others.

Storage 114 includes non-volatile storage for applications and data, and may include fixed or removable disk drives, flash memory devices, and CD-ROM, DVD-ROM, Blu-Ray, HD-DVD, or other magnetic, optical, or solid state storage devices. Parameter estimation engine 122 and refinement engine 124 may be stored in storage 114 and loaded into memory 116 when executed.

Memory 116 includes a random access memory (RAM) module, a flash memory unit, or any other type of memory unit or combination thereof. Processor(s) 102, I/O device interface 104, and network interface 106 are configured to read data from and write data to memory 116. Memory 116 includes various software programs that can be executed by processor(s) 102 and application data associated with said software programs, including parameter estimation engine 122 and refinement engine 124.

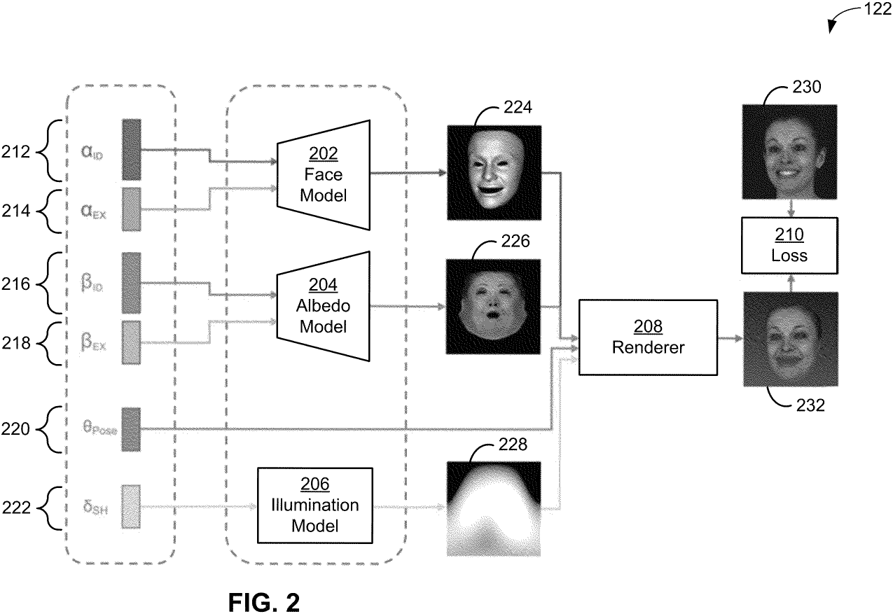

In some embodiments, parameter estimation engine 122 computes parameters that characterize the shape and appearance of an object such as a face. These parameters include (but are not limited to) one or more identity parameters, expression parameters, geometry parameters, albedo parameters, pose parameters, and/or lighting parameters. The parameters are iteratively optimized based on a loss between a rendering of the object based on the parameters and a corresponding target image of the object. The operation of parameter estimation engine 122 is described in further detail below with respect to FIG. 2.

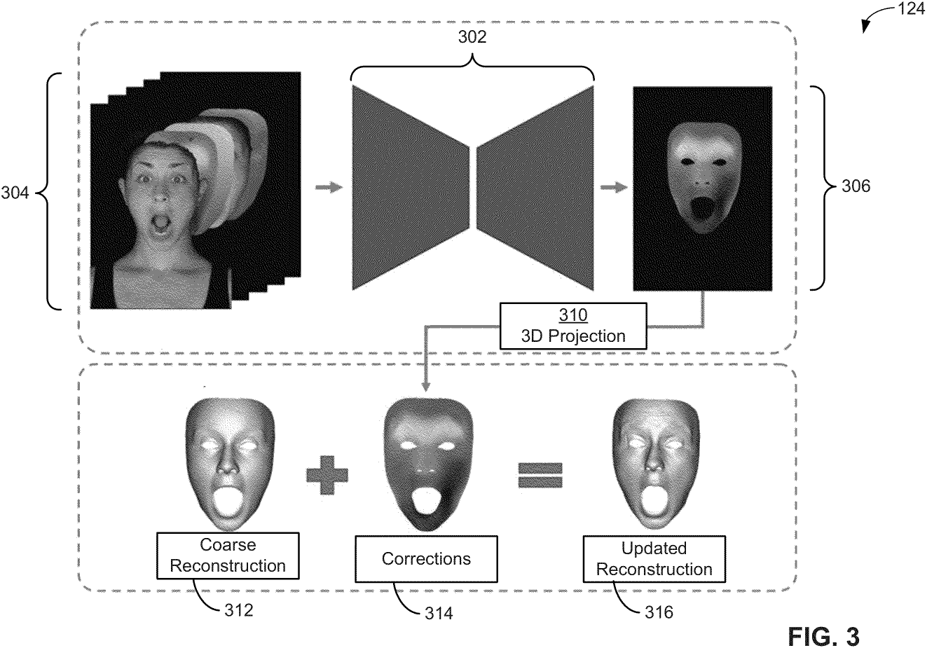

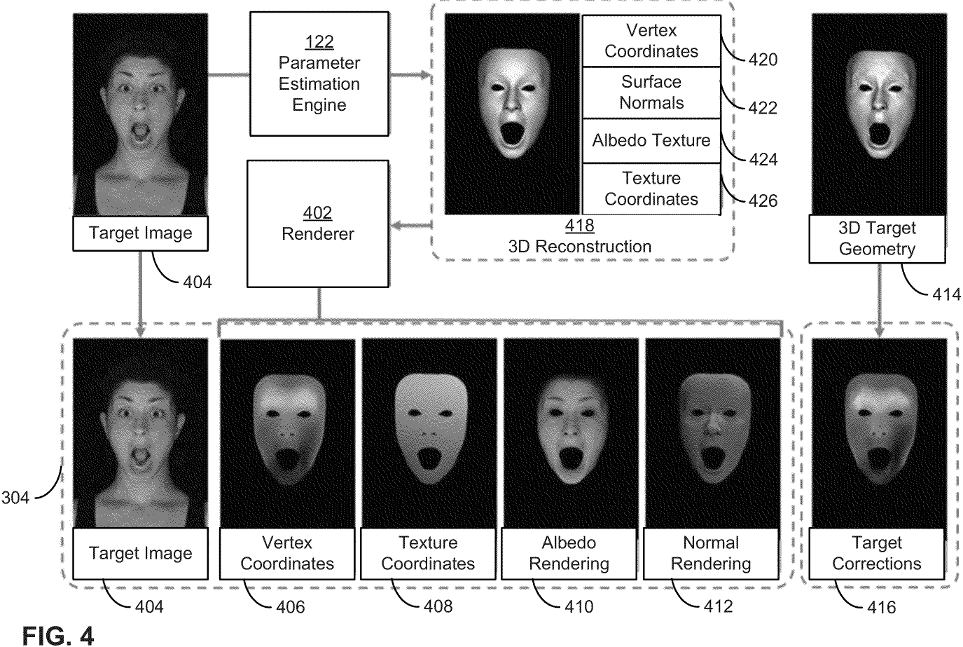

In some embodiments, refinement engine 124 generates corrections to a reconstruction of the object based on the parameters outputted by parameter estimation engine 122. More specifically, refinement engine 124 uses a machine learning model to further optimize spatial coordinates, texture coordinates, and/or other coordinates in the reconstruction based on one or more images of the object. The operation of refinement engine 124 is described in further detail below with respect to FIGS. 3-4.

### Appearance Construction With Deep Geometric Refinement

FIG. 2 illustrates the operation of parameter estimation engine 122 of FIG. 1, according to various embodiments. As shown in FIG. 2, parameter estimation engine 122 uses a face model 202, an albedo model 204, an illumination model 206, a renderer 208, and a set of parameters 212, 214, 216, 218, 220, and 222 to generate a reconstructed image 232 of the face.

More specifically, parameter estimation engine 122 inputs two geometry parameters 212 and 214 into face model 202. Parameter 212 is denoted by α_{ID} and represents facial geometry detail associated with a specific identity (e.g., a specific person). Parameter 214 is denoted by α_{EX} and represents facial geometry detail associated with a specific expression (e.g., a facial expression). Parameter 212 is constrained to have the same value over all images depicting the same person (or entity), while parameter 214 can vary across images of the same person (or entity).

Parameter estimation engine 122 also inputs two parameters 216 and 218 into albedo model 204. Parameter 216 is denoted by β_{ID} and represents shading-free facial color or skin pigmentation associated with a specific identity (e.g., a specific person). Parameter 218 is denoted by β_{EX} and represents shading-free facial color or skin pigmentation associated with a specific expression (e.g., a facial expression). As with parameters 212 and 214, parameter 216 is constrained to have the same value over all images depicting the same person (or entity), while parameter 218 can vary across images of the same person (or entity).

In one or more embodiments, parameters 212, 214, 216, and 218 are represented as one or more vectors. For example, parameters 212 and 214 could be stored in a vector denoted by α, and parameters 216 and 218 could be stored in a vector denoted by β. The α vector could include a first half or portion representing parameter 212 and a second half or portion representing parameter 214. Similarly, the β vector could include a first half or portion representing parameter 216 and a second half or portion representing parameter 218.

In response to the inputted parameters 212 and 214, face model 202 generates a three-dimensional (3D) geometry 224 representing the 3D shape of the face. For example, 3D geometry 224 could include a polygon mesh that defines the 3D shape of the face. Likewise, in response to the inputted parameters 216 and 218, albedo model 204 generates a diffuse albedo texture map 226 representing the shading-free color or pigmentation of the face.

For example, face model 202 and albedo model 204 could be two separate decoder neural networks that are jointly trained as components of a variational autoencoder (VAE). The VAE includes an “identity” encoder that encodes the identity associated with a given subject and an “expression” encoder that encodes the expression of the subject. A latent identity code could be sampled from a distribution that is parameterized by the “identity” encoder based on geometry and albedo data associated with a neutral expression on the face of a given subject and a latent expression code could be sampled from a distribution that is parameterized by the “expression” encoder based on a set of blendweights representing a target facial expression of the subject The identity and expression codes could be concatenated into a vector that is inputted into both decoders. The decoder implementing face model 202 could output 3D geometry 224 of the subject in the target expression, and the decoder implementing albedo model 204 could output albedo texture map 226 of the subject in the target expression. 3D geometry 224 and albedo texture map 226 could then be used to render a face of the subject. The two encoders and two decoders could be trained end-to-end based on an L1 loss between the rendered face and a corresponding captured image of the subject. A Kullback-Liebler (KL) divergence could additionally be used to constrain the identity and expression latent spaces.

Face model 202 and albedo model 204 can also, or instead, be implemented using other types of data-driven models. For example, face model 202 and/or albedo model 204 could include a linear three-dimensional (3D) morphable model that expresses new faces as linear combinations of prototypical faces from a dataset. In another example, face model 202 and/or albedo model 204 could include a fully connected neural network, convolutional neural network (CNN), graph convolution network (GCN), and/or another type of deep neural network that represents faces as nonlinear deformations of other faces in a training dataset.

Parameter estimation engine 122 also inputs one or more parameters 222 (hereinafter “parameters 222”) into illumination model 206. Parameters 222 are denoted by δ_{SH} and represent lighting of the face. In response to the inputted parameters 222, illumination model 206 generates an environment map 228 representing the lighting associated with the face. For example, parameters 222 could represent low-frequency (i.e., soft) lighting as a compact N^{th} order Spherical Harmonics parameter vector. Illumination model 206 could generate environment map 228 under the assumptions that the appearance of the face can be well produced, is under soft lighting, and/or exhibits diffuse Lambertian reflectance.

Parameter estimation engine 122 uses one or more parameters 220 (hereinafter “parameters 220”) to represent a pose (i.e., position and orientation) associated with the face. The parameters 220 are denoted by θ_{Pose}. For example, parameter estimation engine 122 could model the pose as a transformation with six components representing six degrees of freedom. Three of the components could represent a 3D rotation of a head that includes the face, and the other three components could represent a 3D translation of the same head.

Parameter estimation engine 122 uses a renderer 208 to combine 3D geometry 224, diffuse albedo texture map 226, and environment map 228 (hereinafter “maps 224, 226, 228”) into a reconstructed image 232. For example, renderer 208 could include an auto-differentiable renderer that generates image 232 based on a rendering equation into which maps 224, 226, and 228 and parameters 220 are inserted as parameter values.

After the reconstructed image 232 is generated, parameter estimation engine 122 computes a loss 210 between image 232 and a target image 230 of a face. Parameter estimation engine 122 also iteratively optimizes for parameters 212, 214, 216, 218, 220, and 222 based on loss 210. For example, parameter estimation engine 122 could use a coordinate descent technique to iteratively update each of parameters 212, 214, 216, 218, 220, and 222 based on a value of loss 210 that measures how closely the reconstructed image 232 matches the target image 230. Parameter estimation engine 122 could also use renderer 208 to generate a new reconstructed image 232 based on the updated parameters 212, 214, 216, 218, 220, and 222 and compute a new loss 210 between the new reconstructed image 232 and the target image 230. During this coordinate descent technique, parameter estimation engine 122 could iteratively backpropagate values of loss 210 as adjustments to parameters 212, 214, 216, 218, 220, and 222 until the values of loss 210 converge and/or fall below a threshold.

Once values of loss 210 have converged and/or fallen below a threshold, the face rendered in the reconstructed image 232 matches the target image 230 as closely as allowed by the parametric model. Because some or all parameters 212, 214, 216, 218, 220, and 222 are constrained to be within the latent parameter space of a pre-trained data-driven face model, the final set of parameters 212, 214, 216, 218, 220, and 222 produce renderings that look like plausible or realistic faces.

As mentioned above, parameters 212 and 216 are constrained to have the same value for all images depicting the same person (or entity), while parameters 214 and 218 can vary across the images. More specifically, parameter estimation engine 122 can perform optimization of parameters 212, 214, 216, 218, 220, and 222 over multiple target images of a person’s face. During this optimization, parameter estimation engine 122 produces a separate set of parameters 212, 214, 216, 218, 220, and 222 for each target image 230 but enforces the same value for each of parameters 212 and 216 across all of the target images. In maintaining the same value for each of parameters 212 and 216 across the target images, parameter estimation engine 122 reduces the number of unknowns and pools information across the target images, thereby improving the quality and accuracy of rendered images of the person’s face.

FIG. 3 illustrates the operation of refinement engine 124 of FIG. 1, according to various embodiments. As mentioned above, refinement engine 124 uses a machine learning model 302 to further optimize spatial coordinates, texture coordinates, and/or other coordinates related to the shape and/or appearance of a face. These coordinates could be determined based on parameters 212, 214, 216, 218, 220, and 222 generated by parameter estimation engine 122 and/or via another technique. This additional optimization of facial shape and/or appearance corrects for limitations in the amount and type of facial detail that can be captured by models 202, 204, and/or 206. For example, the optimization performed by refinement engine 124 could be used to add structures and/or details (e.g., specific facial features, wrinkles, etc.) to one or more maps 224, 226, 228 associated with parameters 212, 214, 216, 218, 220, and/or 222. These structures and/or details could be missing from a dataset used to train models 202, 204, and/or 206 and/or could reflect limitations in the capabilities of models 202, 204, and/or 206. These structures and/or details could also be missing from a coarse reconstruction 312 of a face that is generated based on maps 224, 226, and/or 228 and/or parameters 212, 214, 216, 218, 220, and/or 222.

In one or more embodiments, machine learning model 302 includes a feedforward neural network with a U-Net architecture. Input 304 into the U-Net includes a concatenation of a target image of a face with additional “screen space” (i.e., per-pixel locations in the target image) and/or UV-space (i.e., per-pixel locations in a two-dimensional (2D) texture map for the face) data derived from parameters 212, 214, 216, 218, 220, and/or 222. For example, input 304 could include (but is not limited to) a multi-channel image with the same resolution as the target image. The multi-channel image could include three channels storing per-pixel colors in the target image, three channels storing per-pixel 3D vertex coordinates of the face, two channels storing per-pixel UV texture coordinates for the face, three channels storing per-pixel albedo colors for the face, and/or three channels storing per-pixel surface normals for the face.

Some or all of input 304 can be obtained by rendering the face according to parameters 212, 214, 216, 218, 220, and/or 222 generated by parameter estimation engine 122. For example, input 304 could include a target image 230 that is used by parameter estimation engine 122 to optimize for parameters 212, 214, 216, 218, 220, and 222. Input 304 could also include one or more maps (e.g., maps 224, 226, and/or 228) that are outputted by one or more models 202, 204, and/or 206 based on the optimized values of parameters 212, 214, 216, 218, 220, and/or 222 during generation of a reconstructed image 232 that is as close as possible to the target image 230. In another example, input 304 could include a new target image that is different from the target image 230 used by parameter estimation engine 122 to optimize for parameters 212, 214, 216, 218, 220, and 222. In this example, input 304 would also include one or more maps (e.g., maps 224, 226, and/or 228) that are generated based on parameters 212, 216, and 222 from parameter estimation engine 122 and one or more parameters 214, 218, and/or 220 representing a new expression and/or pose associated with the new target image. This new expression and/or pose could be estimated and/or determined based on geometry and/or albedo information associated with parameters 212, 214, 216 and/or 218; using facial landmarks in the new target image; by parameter estimation engine 122; and/or using other types of data or techniques.

In some embodiments, the U-Net includes a convolutional encoder that performs downsampling of feature maps associated with input 304 until a lowest resolution is reached. The U-Net also includes a convolutional decoder that performs upsampling of the feature maps back until the original resolution of input 304 is reached. The U-Net further includes skip links that connect intermediary layers of image representations with the same resolution. Output 306 of the U-Net includes an image of the face in the same pose as in the target image included in input 304. This output 306 image includes “screen space” offsets for vertex and/or texture coordinates in input 304. Refinement engine 124 performs a 3D projection 310 that converts the “screen space” offsets into a corresponding set of corrections 314 in a 3D canonical space. These corrections 314 are combined with coarse reconstruction 312 of the face in the same 3D canonical space (e.g., as generated based on parameters 212, 214, 216, 218, 220, and/or 222) to produce an updated reconstruction 316 that includes the facial details generated by the U-Net.

Output 306 can also, or instead, include vertex and/or texture coordinates in the “screen space” of the target image. These coordinates can be directly converted via 3D projection 310 into corrections 314 that include vertex and/or texture coordinates in updated reconstruction 316.

When machine learning model 302 is used to generate multiple sets of corrections 314 for multiple views and/or target images of the same face, refinement engine 124 combines these sets of offsets and/or coordinates into a single set of corrections 314 in the 3D canonical space. For example, refinement engine 124 could generate two or more sets of input 304 from two or more target images of the same face from different views. Refinement engine 124 could apply machine learning model 302 to each set of input 304 and obtain a corresponding output 306 from machine learning model 302. Refinement engine 124 could use 3D projection 310 to convert each set of output 306 into a corresponding set of corrections 314 in the 3D canonical space. When a point in the 3D canonical space is associated with two or more corrections 314, refinement engine 124 could calculate a final correction to the point as a weighted average of the two or more corrections 314. Within the weighted average, each correction could be weighted by a dot product of the surface normal of the point and a vector representing the camera view direction associated with the target image from which the correction was generated. In other words, the contribution of a given correction to the final correction could be scaled by a measure of how visible the point is in a corresponding target image.

FIG. 4 illustrates the preparation of training data for machine learning model 302 of FIG. 3, according to various embodiments. The training data includes a target image 404 of a face, which is paired with a corresponding 3D target geometry 414 of the same face. In some embodiments, 3D target geometry 414 includes a 3D mesh of the face. The mesh can be captured via a scan of the face using a multiview photogrammetry system and/or another type of facial capture system.

Target image 404 is processed by parameter estimation engine 122 to produce a 3D reconstruction 418 that includes vertex coordinates 420, surface normals 422, an albedo texture 424, and/or texture coordinates 426 associated with the face. For example, parameter estimation engine 122 could use renderer 208 and one or more models 202, 204, 206 to determine values of parameters 212, 214, 216, 218, 220, and/or 222 that minimize the loss between target image 404 and a corresponding reconstructed image 232. Parameter estimation engine 122 could then obtain 3D reconstruction 418 as one or more maps 224, 226, 228 outputted by one or more models 202, 204, 206 based on the determined values of parameters 212, 214, 216, 218, 220, and/or 222.

A renderer 402 (which can include renderer 208 and/or a different renderer) is used to convert 3D reconstruction 418 into additional input 304 associated with target image 404. More specifically, renderer 402 converts the data in 3D reconstruction 418 into a set of vertex coordinates 406, a set of texture coordinates 408, an albedo rendering 410, and a normal rendering 412. For example, renderer 402 could output a separate set of vertex coordinates 406, texture coordinates 408, albedo values, and/or normal values for each pixel location in target image 404.

The same target image 404 is combined with vertex coordinates 406, texture coordinates 408, albedo rendering 410, and normal rendering 412 from renderer 402 to form input 304 into machine learning model 302. 3D target geometry 414 is also used to generate a set of target corrections 416 in the “screen space” of target image 404. For example, 3D target geometry 414 could be converted into a set of target vertex coordinates for each pixel location in target image 404. Target corrections 416 could then be generated as differences between the target vertex coordinates and vertex coordinates 420 in 3D reconstruction 418 generated from the same target image 404. Target corrections 416 could also, or instead, be set to the target vertex coordinates. In another example, a set of per-vertex offsets could be computed between vertex coordinates 420 in 3D reconstruction 418 and corresponding vertex coordinates in 3D target geometry 414. These per-vertex offsets could then be converted (e.g., by renderer 402) into target corrections 416 that include per-pixel offsets in the “screen space” of target image 404. When machine learning model 302 is trained to generate corrections to texture coordinates 408 (in lieu of or instead of corrections to vertex coordinates 406), target corrections 416 could be generated as differences between the target texture coordinates for each pixel location in target image 404 and the corresponding texture coordinates 426 in 3D reconstruction 418.

After the training data is prepared for multiple target image-3D target geometry pairs, machine learning model 302 is trained in a way that minimizes one or more losses associated with output 306 and target corrections 416. For example, machine learning model 302 could be trained using an Adam optimization technique and the following loss function:

$$L \left(\hat{I} , I , M\right) = {\left‖M ⊙ \left(\hat{I} - I\right)\right‖}_{1} + λ {\left‖M ⊙ \left(∇ \hat{I} - ∇ I\right)\right‖}_{1}$$

In Equation 1, I̅ represents target corrections 416, I represents a corresponding set of corrections in output 306 from machine learning model 302, M represents a visibility mask, and ⊙ denotes an element-wise product. Further, λ is a parameter that controls the amount with which high-frequency noise is penalized. When λ=0, the loss function corresponds to a regular L1 loss between output 306 and target corrections 416. When λ>0, the loss function includes the L1 loss as well as a gradient loss between output 306 and target corrections 416.

While the operation of parameter estimation engine 122 and refinement engine 124 has been described above with respect to the reconstruction of faces, those skilled in the art will appreciate that parameter estimation engine 122 and refinement engine 124 can be adapted to perform appearance construction and geometric refinement for other types of objects. For example, parameter estimation engine 122 and refinement engine 124 could be used to generate and refine reconstructions and/or renderings of bodies, body parts, animals, and/or other types of objects.

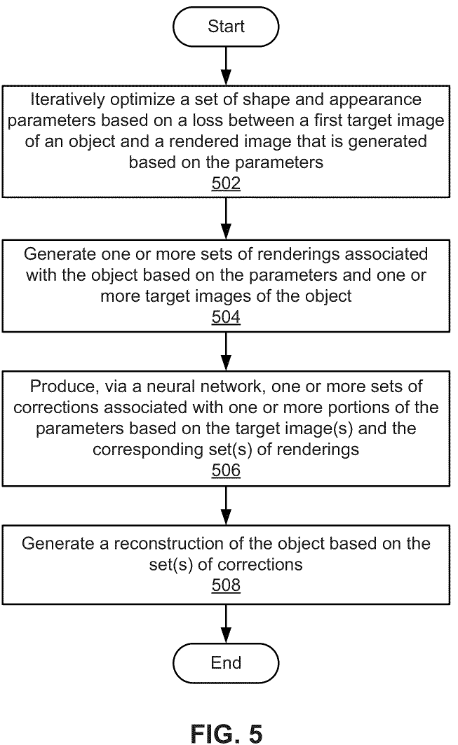

FIG. 5 is a flow diagram of method steps for performing shape and appearance reconstruction, according to various embodiments. Although the method steps are described in conjunction with the systems of FIGS. 1-3, persons skilled in the art will understand that any system configured to perform the method steps in any order falls within the scope of the present disclosure.

As shown, in step 502, parameter estimation engine 122 iteratively optimizes a set of parameters based on a loss between a first target image of an object and a rendered image that is generated based on the parameters. For example, parameter estimation engine 122 could use a data-driven model of a face (or another type of object) to generate a 3D geometry, an albedo texture map, an environment map, and/or another map based on parameters representing the identity, expression, geometry, albedo, and/or lighting of the face. Parameter estimation engine 122 could also use an auto-differentiable renderer to generate a reconstructed image of the face, given the maps and one or more additional parameters that represent the pose of the face. Parameter estimation engine 122 could calculate the loss between the reconstructed image and the first target image and iteratively backpropagate the loss as adjustments to the parameters until the parameters converge, the loss falls below a threshold, and/or another condition is met.

Next, in step 504, refinement engine 124 generates one or more sets of renderings associated with the object based on the set of parameters and one or more target images of the object. For example, refinement engine 124 could produce a mesh vertex coordinate rendering, texture coordinate rendering, albedo rendering, and/or surface normal rendering based on the parameters and a pose associated with each target image of the object. Each of the renderings could have the same resolution as the corresponding target image and specify a set of values for each pixel location in the target image. The target image(s) used to produce the renderings in step 504 can be the same as or different from the first target image used to determine the parameters in step 502. When the target image(s) differ from the first target image used to determine the parameters in step 502, one or more parameters representing the expression and/or pose associated with the target image(s) could be adapted to the target image(s) prior to generating the renderings.

In step 506, refinement engine 124 produces, via a neural network, one or more sets of corrections associated with one or more portions of the parameters based on the target image(s) and the corresponding set(s) of renderings. For example, refinement engine 124 could input a multi-channel image that includes color values in a given target image and per-pixel values in the corresponding set of renderings into a U-Net. The U-Net could include a convolutional encoder that gradually downsamples the inputted data until a lowest resolution is reached. The U-Net could also include a convolutional decoder that gradually upsamples the feature maps starting with the lowest resolution until the original resolution of the multi-channel image is reached. The U-Net could also include skip links that connect intermediary layers of image representations with the same resolution. After the U-Net has processed a given multi-channel image, the U-Net could output corrections that include a set of offsets to spatial coordinates or texture coordinates in the renderings. Alternatively or additionally, the U-Net could output corrections that include a new set of spatial coordinates or texture coordinates in the renderings.

in step 508, refinement engine 124 generates a reconstruction of the object based on the set(s) of corrections generated in step 506. Continuing with the above example, refinement engine 124 could add the offsets outputted by the U-Net to the corresponding “screen space” maps to produce updates to the spatial coordinates and/or texture coordinates. Refinement engine 124 could also, or instead, convert the “screen space” offsets outputted by the U-Net into offsets in a 3D canonical space before applying the offsets to a set of points representing a coarse reconstruction of the object in the 3D canonical space. If the corrections include a new set of spatial coordinates or texture coordinates, refinement engine 124 could replace the original spatial coordinates or texture coordinates with the new spatial coordinates or texture coordinates outputted by the U-Net.

When multiple sets of corrections are produced in step 506 (e.g., from multiple target images or views of the object), refinement engine 124 aggregates the sets of corrections into a single set of corrections that is used to generate the reconstruction of the object. For example, refinement engine 124 could generate a “final” correction to the spatial or texture coordinates of a vertex in the 3D canonical space as a weighted combination of two or more corrections to the vertex. Within the weighted combination, each correction is weighted based on a “visibility” of the vertex in a corresponding target image. This “visibility” can be calculated as the dot product of the surface normal associated with the vertex and a vector representing the camera view direction associated with the target image.

in sum, the disclosed techniques perform reconstruction of faces and/or other types of objects. A parametric model is used to solve for shape and appearance parameters that represent a reconstruction of an object. The parameters can include (but are not limited to) an identity parameter, an expression parameter, a geometry parameter, an albedo parameter, a pose parameter, and/or a lighting parameter. A differentiable renderer is used to generate a reconstructed image of the object based on the parameters. A loss between the reconstructed image and a target image is used to iteratively optimize the parameters until the parameters converge, the loss falls below a threshold, and/or another condition is met.

A machine learning model is then used to refine a coarse reconstruction of the object that is generated based on the parameters. For example, the machine learning model could be used to add specific structures and skin detail that cannot be captured by the parametric model to the coarse reconstruction. The machine learning model includes a deep neural network with a U-Net architecture. Input into the machine learning model includes a target image of the object, as well as a mesh vertex coordinate rendering, texture coordinate rendering, albedo rendering, and/or surface normal rendering in the “screen space” of the target image and/or a UV space associated with a texture map for the object. These renderings are produced by a renderer based on the parameters outputted by the parametric model and a pose associated with the target image. The machine learning model performs downsampling and upsampling operations on feature maps associated with the input and generates output that includes corrections to one or more of the renderings in the input. The corrections can then be applied to the corresponding renderings to produce an updated set of renderings of the object. The corrections can also, or instead, be converted from the screen space of the target image into a 3D canonical space. The corrections can then be applied to the coarse reconstruction of the object in the 3D canonical space to generate an “updated” reconstruction that includes the details predicted by the machine learning model.

One technical advantage of the disclosed techniques relative to the prior art is that faces and other types of objects can be reconstructed under uncontrolled “in the wild” conditions. Accordingly, the disclosed techniques can be used to perform appearance reconstruction for objects that cannot be captured under controlled studio-like settings. Another technical advantage of the disclosed techniques is an improvement in reconstruction accuracy over conventional parametric models that are created from limited datasets of faces or other objects. For example, the disclosed techniques could be used to add granular details to a face after the reconstruction of the face is produced via a conventional parametric model. These added details can further be used to improve the identification, classification, and/or other analyses related to the object. These technical advantages provide one or more technological improvements over prior art approaches.

1. In some embodiments, a computer-implemented method for performing shape and appearance reconstruction comprises generating a first set of renderings associated with an object based on a set of parameters that represent a reconstruction of the object in a first target image; producing, via a neural network, a first set of corrections associated with at least a portion of the set of parameters based on the first target image and the first set of renderings; and generating an updated reconstruction of the object based on the first set of corrections.

2. The computer-implemented method of clause 1, further comprising training the neural network based on a training dataset that includes a set of target corrections.

3. The computer-implemented method of any of clauses 1-2, further comprising producing, via the neural network, a second set of corrections associated with the at least a portion of the set of parameters based on a second target image of the object and a second set of renderings associated with the object, wherein generating the updated reconstruction is further based on an aggregation of the first set of corrections and the second set of corrections.

4. The computer-implemented method of any of clauses 1-3, wherein the aggregation comprises a weighted combination of the first set of corrections and the second set of corrections, and wherein the weighted combination is generated based on a first set of visibilities associated with the first set of corrections and a second set of visibilities associated with the second set of corrections.

5. The computer-implemented method of any of clauses 1-4, wherein generating the updated reconstruction comprises converting the first set of corrections into a second set of corrections in a canonical space associated with the updated reconstruction; and generating the updated reconstruction in the canonical space based on the second set of corrections.

6. The computer-implemented method of any of clauses 1-5, wherein the first set of corrections comprises a set of offsets to a set of coordinates included in the first set of renderings.

7. The computer-implemented method of any of clauses 1-6, wherein the set of coordinates comprises at least one of a spatial coordinate or a texture coordinate.

8. The computer-implemented method of any of clauses 1-7, wherein the first set of renderings comprises at least one of a vertex coordinate rendering, a texture coordinate rendering, an albedo rendering, or a surface normal rendering.

9. The computer-implemented method of any of clauses 1-8, further comprising generating the set of parameters based on a loss between the first target image and a rendered image that is generated based on the set of parameters.

10. The computer-implemented method of any of clauses 1-9, wherein the set of parameters comprises at least one of an identity parameter, an expression parameter, a geometry parameter, an albedo parameter, a pose parameter, or a lighting parameter.

11. In some embodiments, one or more non-transitory computer readable media store instructions that, when executed by one or more processors, cause the one or more processors to perform the steps of generating a first set of renderings associated with an object based on a set of parameters that represent a reconstruction of the object in a first target image; producing, via a neural network, a first set of corrections associated with at least a portion of the set of parameters based on the first target image and the first set of renderings; and generating an updated reconstruction of the object based on the first set of corrections.

12. The one or more non-transitory computer readable media of clause 11, wherein the instructions further cause the one or more processors to perform the step of training the neural network based on an L1 loss between the first set of corrections and a corresponding set of target corrections and a gradient loss between the first set of corrections and the corresponding set of target corrections.

13. The one or more non-transitory computer readable media of any of clauses 11-12, wherein the instructions further cause the one or more processors to perform the steps of producing, via the neural network, a second set of corrections associated with the at least a portion of the set of parameters based on a second target image of the object and a second set of renderings associated with the object, wherein generating the updated reconstruction is further based on an aggregation of the first set of corrections and the second set of corrections.

14. The one or more non-transitory computer readable media of any of clauses 11-13, wherein the aggregation is generated based on a first set of visibilities associated with the first set of corrections and a second set of visibilities associated with the second set of corrections.

15. The one or more non-transitory computer readable media of any of clauses 11-14, wherein generating the reconstruction comprises converting the first set of corrections into a second set of corrections in a canonical space associated with the updated reconstruction; and generating the updated reconstruction in the canonical space based on the second set of corrections and a coarse reconstruction associated with the set of parameters.

16. The one or more non-transitory computer readable media of any of clauses 11-15, wherein the first set of corrections comprises a set of offsets to a set of coordinates included in the first set of renderings.

17. The one or more non-transitory computer readable media of any of clauses 11-16, wherein the set of coordinates comprises at least one of a spatial coordinate associated with a geometry for the object or a texture coordinate associated with a texture for the object.

18. The one or more non-transitory computer readable media of any of clauses 11-17, wherein the set of parameters is associated with a latent space of one or more decoder neural networks.

19. The one or more non-transitory computer readable media of any of clauses 11-18, wherein the neural network comprises a convolutional encoder that performs downsampling of a first set of feature maps associated with the first target image and the first set of renderings and a convolutional decoder that performs upsampling of a second set of feature maps associated with target image and the first set of renderings.

20. In some embodiments, a system comprises one or more memories that store instructions, and one or more processors that are coupled to the one or more memories and, when executing the instructions, are configured to generate a first set of renderings associated with an object based on a set of parameters that represent a reconstruction of the object in a first target image; produce, via a neural network, a first set of corrections associated with at least a portion of the set of parameters based on the first target image and the first set of renderings; and generate an updated reconstruction of the object based on the first set of corrections.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for performing shape and appearance reconstruction, the computer-implemented method comprising:
generating a first set of renderings associated with an object based on a set of parameters that represent a reconstruction of the object in a first target image;
producing, via a neural network, a first set of corrections associated with at least a portion of the set of parameters based on the first target image and the first set of renderings; and
generating an updated reconstruction of the object based on the first set of corrections.

2. The computer-implemented method of claim 1, further comprising training the neural network based on a training dataset that includes a set of target corrections.

3. The computer-implemented method of claim 1, further comprising:
producing, via the neural network, a second set of corrections associated with the at least a portion of the set of parameters based on a second target image of the object and a second set of renderings associated with the object,
wherein generating the updated reconstruction is further based on an aggregation of the first set of corrections and the second set of corrections.

4. The computer-implemented method of claim 3, wherein the aggregation comprises a weighted combination of the first set of corrections and the second set of corrections, and wherein the weighted combination is generated based on a first set of visibilities associated with the first set of corrections and a second set of visibilities associated with the second set of corrections.

5. The computer-implemented method of claim 1, wherein generating the updated reconstruction comprises:
converting the first set of corrections into a second set of corrections in a canonical space associated with the updated reconstruction; and
generating the updated reconstruction in the canonical space based on the second set of corrections.

6. The computer-implemented method of claim 1, wherein the first set of corrections comprises a set of offsets to a set of coordinates included in the first set of renderings.

7. The computer-implemented method of claim 6, wherein the set of coordinates comprises at least one of a spatial coordinate or a texture coordinate.

8. The computer-implemented method of claim 1, wherein the first set of renderings comprises at least one of a vertex coordinate rendering, a texture coordinate rendering, an albedo rendering, or a surface normal rendering.

9. The computer-implemented method of claim 1, further comprising generating the set of parameters based on a loss between the first target image and a rendered image that is generated based on the set of parameters.

10. The computer-implemented method of claim 1, wherein the set of parameters comprises at least one of an identity parameter, an expression parameter, a geometry parameter, an albedo parameter, a pose parameter, or a lighting parameter.

11. One or more non-transitory computer readable media storing instructions that, when executed by one or more processors, cause the one or more processors to perform the steps of:
generating a first set of renderings associated with an object based on a set of parameters that represent a reconstruction of the object in a first target image;
producing, via a neural network, a first set of corrections associated with at least a portion of the set of parameters based on the first target image and the first set of renderings; and
generating an updated reconstruction of the object based on the first set of corrections.

12. The one or more non-transitory computer readable media of claim 11, wherein the instructions further cause the one or more processors to perform the step of training the neural network based on an L1 loss between the first set of corrections and a corresponding set of target corrections and a gradient loss between the first set of corrections and the corresponding set of target corrections.

13. The one or more non-transitory computer readable media of claim 11, wherein the instructions further cause the one or more processors to perform the steps of:
producing, via the neural network, a second set of corrections associated with the at least a portion of the set of parameters based on a second target image of the object and a second set of renderings associated with the object,
wherein generating the updated reconstruction is further based on an aggregation of the first set of corrections and the second set of corrections.

14. The one or more non-transitory computer readable media of claim 13, wherein the aggregation is generated based on a first set of visibilities associated with the first set of corrections and a second set of visibilities associated with the second set of corrections.

15. The one or more non-transitory computer readable media of claim 11, wherein generating the reconstruction comprises:
converting the first set of corrections into a second set of corrections in a canonical space associated with the updated reconstruction; and
generating the updated reconstruction in the canonical space based on the second set of corrections and a coarse reconstruction associated with the set of parameters.

16. The one or more non-transitory computer readable media of claim 11, wherein the first set of corrections comprises a set of offsets to a set of coordinates included in the first set of renderings.

17. The one or more non-transitory computer readable media of claim 16, wherein the set of coordinates comprises at least one of a spatial coordinate associated with a geometry for the object or a texture coordinate associated with a texture for the object.

18. The one or more non-transitory computer readable media of claim 11, wherein the set of parameters is associated with a latent space of one or more decoder neural networks.

19. The one or more non-transitory computer readable media of claim 11, wherein the neural network comprises a convolutional encoder that performs downsampling of a first set of feature maps associated with the first target image and the first set of renderings and a convolutional decoder that performs upsampling of a second set of feature maps associated with target image and the first set of renderings.

20. A system, comprising:
one or more memories that store instructions, and
one or more processors that are coupled to the one or more memories and,
when executing the instructions, are configured to:
generate a first set of renderings associated with an object based on a set of parameters that represent a reconstruction of the object in a first target image;
produce, via a neural network, a first set of corrections associated with at least a portion of the set of parameters based on the first target image and the first set of renderings; and
generate an updated reconstruction of the object based on the first set of corrections.
